(19) United States
(12) Patent Application Publication
(10) Pub. No.: US 2014/0181345 A1
(43) Pub. Date: Jun. 26, 2014

(54) HIDDEN I/O CONNECTOR ASSEMBLY FOR MOBILE COMPUTING DEVICES

(71) Applicant: NVIDIA CORPORATION, Santa Clara, CA (US)

(72) Inventors: Archer Huang, Shanghai (CN); Victor Chen, Shenzhen (CN); Susan Tan, Shenzhen (CN)

(73) Assignee: NVIDIA CORPORATION, Santa Clara, CA (US)

(21) Appl. No.: 13/724,267

(22) Filed: Dec. 21, 2012

(51) Int. Cl. G06F 13/40

(52) U.S. Cl. CPC G06F 13/4063
USPC 710/300

(57) ABSTRACT

A mobile computing device comprising a rotatable I/O port module that includes a plurality of I/O ports providing connections with external electronic devices. The I/O port module is rotatable in relative to the main body of the mobile device between a working state in which the I/O ports are externally accessible to a user and a hidden state in which the I/O ports are externally hidden. The rotation may be controlled by a user through any feasible manner, such as exerting a tangential force, a physical switch or an on-screen soft button, in association with suitable hardware and software components. The rotatable I/O port module may be physically coupled with the main body of the mobile computing device through a rotational axial connector which may also provides electrical connections between the rotational I/O module and the main body.

### TECHNICAL FIELD

The present disclosure relates generally to the field of mobile computing devices and more specifically to the field of input/output (I/O) ports for mobile computing devices.

### BACKGROUND

Mobile computing devices, such as laptops, PDAs, media players, touchpads, smartphones, etc., have evolved to become more and more sophisticated with faster speed and greater data handling capabilities to interact with wide varieties of external electronic devices, such as printers, scanners, cameras, speakers, disk drives, network adaptor, video game players, storage devices, or other computers and so on. Conventionally, these external devices communicate with the mobile computing device via the standard I/O ports built into mobile computing devices, such types of ports as parallel ports, Universal Serial Bus (USB), mini-USB, micro-Secure Digital (SD) card slot, High Definition Multimedia Interface (HDMI), or Subscriber Identity Module (SIM) card slot.

Each mobile computing device has a particular well-designed exterior profile and dimensions to suit the taste of potential consumers. While manufactures continuously decrease the thickness and weight of the mobile computing devices, many popular mobile computing devices lack built-in standard I/O ports for purposes of preserving their portability and aesthetics. Aesthetics is increasingly important for modern handheld devices. For example, a USB 2.0 or a 3.0 port is too large to be used in new generations of such devices.

Instead, non-standard I/O ports have been used for data transmission between mobile computing devices with the external devices. Thus, special external adaptors are often required for connections because most of the external devices carry only standard I/O ports. For example, as illustrated in FIG. 1A, an adaptor 106 with extension cable 107 customized for a certain model of mobile computing device 101 has one end connector 105 fitting the non-standard I/O port 104 on the mobile computing device and another end connector 108 being a standard I/O port. FIG. 1B illustrates another example of an adaptor in prior art. The adaptor 110 has two end connectors, 105 and 108, that operate in the same manner as the one in FIG. 1A except that there is no extension cable in between the end connectors.

More generally to computing devices, the conducting components of conventional built-in I/O ports are constantly exposed to the outside environment. Consequently, user activities such as frequent plugging and unplugging operations or inadvertent physical contact with the conducting components make the computing devices susceptible to severe damage caused by Electrostatic discharge (ESD), including data loss, system crash or even device damage. In addition, static electricity accumulated on the devices is prone to attracting dust into the I/O ports and thereby affects their connectivity. Inadvertent contact with water could also result in similar damage.

Therefore, it would be advantageous to provide built-in standard I/O ports for mobile computing devices to eliminate the need for external adaptors without affecting the aesthetics and portability of the mobile computing devices. It would also advantageous to provide I/O ports for computing devices offering protection against disturbances from the outside environment.

### SUMMARY OF THE INVENTION

Accordingly, embodiments of the present disclosure provide a mechanism to assemble standard I/O ports in a small size mobile computing device. The mechanism is also effective in protecting the I/O ports that are built into the computing device in general against outside disturbances from the outside environment when they are not in use. Embodiments of the present disclosure advantageously include a rotating I/O connector assembly that can render the I/O connectors hidden when not in use and thereby protect the connectors while offering aesthetics to the outside design.

In one embodiment of present disclosure, a computing device comprises a display panel, a main component board, a bus, a main processor, a memory, a main body with a slot and a rotatable I/O port module contained within the slot. The I/O port module comprises a plurality of I/O ports that are communicatively coupled to the main component board. The I/O port module is rotatable relative to the main body of the computing device between a first position in which the plurality of I/O ports are externally accessible and a second position in which the plurality of I/O ports are externally hidden and thus protected from the outside environment.

In another embodiment of present disclosure, a rotatable I/O port module for use in a computing device comprises a plurality of I/O ports, a module body and a rotatable axial connector. Each of the I/O ports provides connections for the computing device with an external electronic device. The I/O ports are contained within the module body. The rotatable axial connector rotatably couples the I/O port module to the computing device main body. The I/O port module is rotatable relative to the main body of the computing device between a first position wherein said plurality of I/O ports are externally accessible and a second position wherein said plurality of I/O ports are externally hidden. In the hidden state, the connector assembly may resemble the edge of the device thereby providing pleasing aesthetics to the device.

In another embodiment of present disclosure, a mobile computing device comprises a display panel, a main component board, a bus, a main processor, a memory, a main body with an edge disposed slot and a rotatable I/O port module contained within the slot. The I/O port module comprises a plurality of I/O ports, a module body and a rotatable axial connector. The I/O module is communicatively coupled to the main component board. The I/O port module is rotatable relative to the main body of the mobile computing device between a first position in which the plurality of I/O ports are externally accessible and a second position in which the plurality of I/O ports are externally hidden.

The foregoing is a summary and thus contains, by necessity, simplifications, generalizations and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

Embodiments of the present invention will be better understood from a reading of the following detailed description, taken in conjunction with the accompanying drawing figures in which like reference characters designate like elements and in which:

FIG. 1A illustrates a non-standard I/O port to USB port adaptor with an extension cable used to provide a USB port for connection between the mobile computing device with an external USB device in accordance with the prior art.

FIG. 1B illustrates a non-standard I/O port to USB port adaptor without an extension cable used to provide a USB port for connection between the mobile computing device with an external USB device in accordance with the prior art.

FIG. 2A illustrates an exterior view of a mobile computing device with a rotatable I/O port module being in the working or exposed, in accordance with an embodiment of the present disclosure.

FIG. 2B illustrates an exterior view of a mobile computing device with a rotatable I/O port board being in the hidden state, in accordance with an embodiment of the present disclosure.

FIG. 2C illustrates an exterior view of a mobile computing device with a rotatable I/O port module being in the rotating state, in accordance with an embodiment of the present disclosure.

FIG. 3A illustrates the perspective view of a mobile computing device with a rotatable I/O port module being in the hidden state and connected to the main board of the mobile computing device in accordance with an embodiment of the present disclosure.

FIG. 3B illustrates the perspective view of a mobile computing device with a rotatable I/O port module being in the working or exposed state and connected to the main board of the mobile computing device in accordance with an embodiment of the present disclosure.

FIG. 4A illustrates a first rotation mechanism of the rotatable I/O port module relative to the main body of the mobile computing device in accordance with an embodiment of the present disclosure in which a user can actuate the rotation by directly exerting a tangential force on the outside edge of the module.

FIG. 4B illustrates a second rotation mechanism of the rotatable I/O port module relative to the main body of the mobile computing device in accordance with an embodiment of the present disclosure where the user can actuate the rotation by pulling the module out and then exerting a tangential force on the outside edge of the module.

FIG. 4C illustrates a third rotation mechanism of the rotatable I/O port module relative to the main body of the mobile computing device in accordance with an embodiment of the present disclosure where the rotation can be actuated by a user input.

FIG. 5 depicts the configuration of a rotatable I/O port module in accordance with an embodiment of the present disclosure.

FIG. 6 is a functional block diagram describing a general purpose mobile computing device comprising a rotatable I/O port module in accordance with an embodiment of present disclosure.

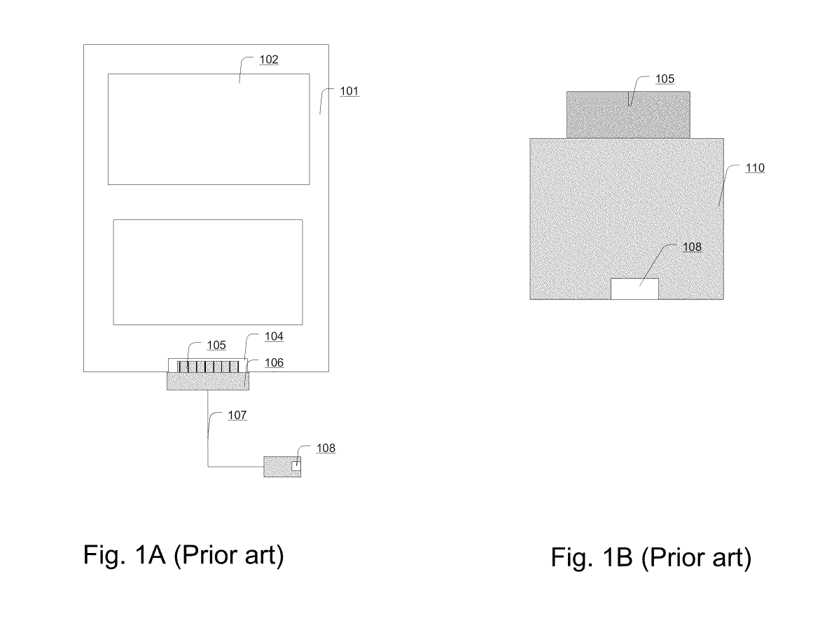

### DETAILED DESCRIPTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail so as not to unnecessarily obscure aspects of the embodiments of the present invention. The drawings showing embodiments of the invention are semi-diagrammatic and not to scale and, particularly, some of the dimensions are for the clarity of presentation and are shown exaggerated in the drawing Figures. Similarly, although the views in the drawings for the ease of description generally show similar orientations, this depiction in the Figures is arbitrary for the most part. Generally, the invention can be operated in any orientation.

### NOTATION AND NOMENCLATURE

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of a computer system, or similar electronic computing device, that manipulates and transforms data represented as physical (electronic) quantities within the computer system's registers and memories and other computer readable media into other data similarly represented as physical quantities within the computer system memories or registers or other such information storage, transmission or display devices. When a component appears in several embodiments, the use of the same reference numeral signifies that the component is the same component as illustrated in the original embodiment.

### Hidden I/O Connector Assembly for Mobile Computing Devices

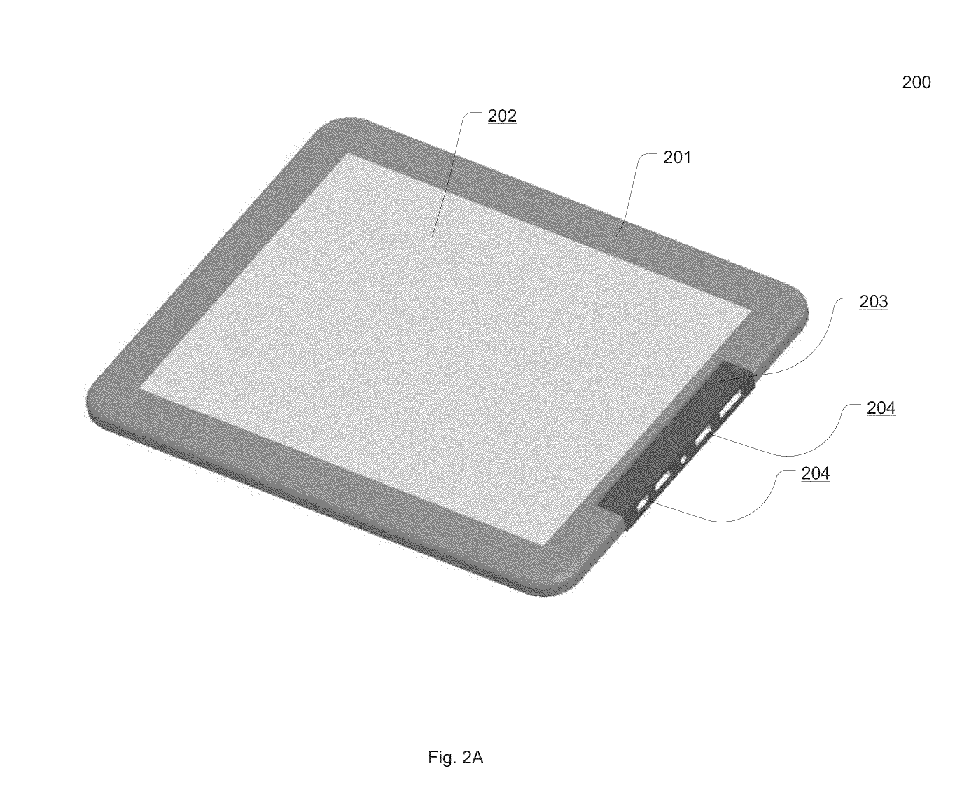

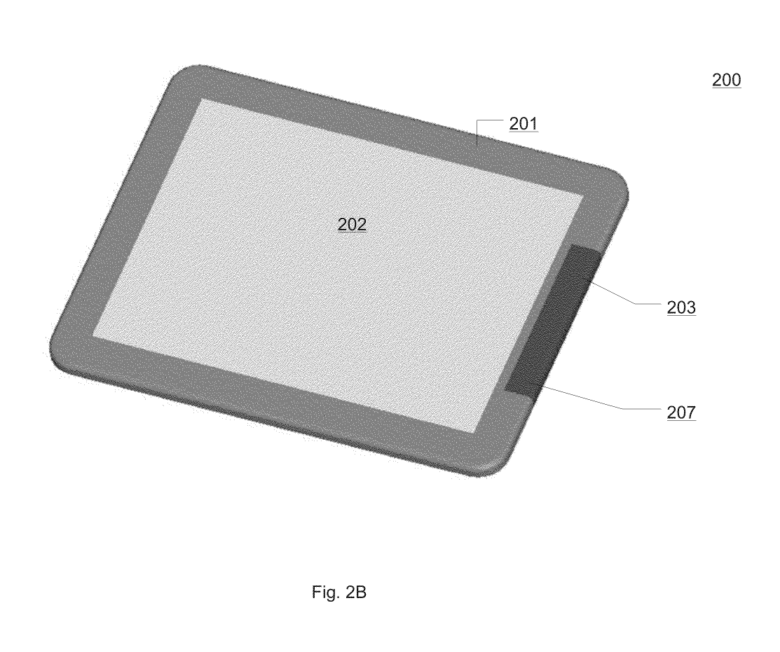

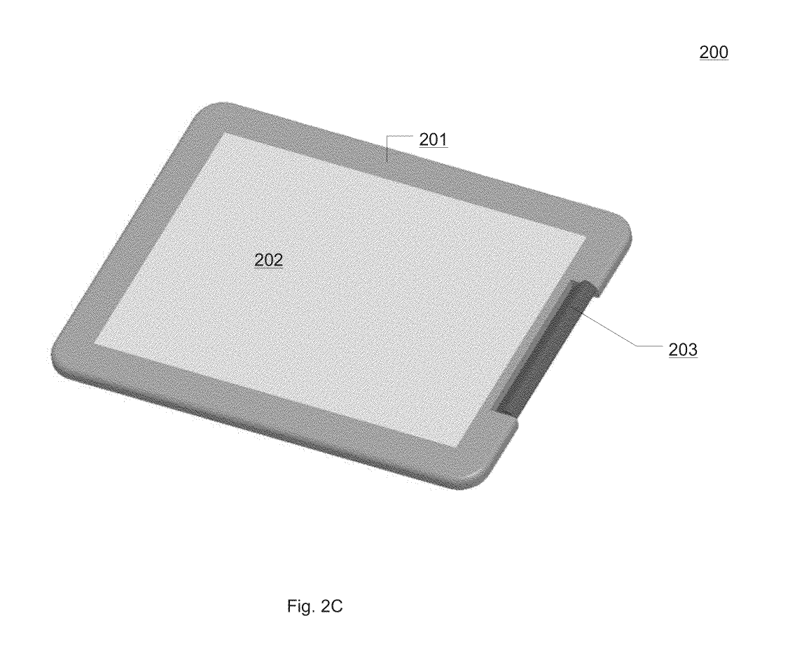

FIG. 2A-2C illustrate the exterior views of a mobile computing device 200 in accordance with embodiments of the present disclosure. The mobile computing device 200 comprises a main body 201, a display panel 202 and an I/O port module 203 that is rotatable relative to the main body 201. When one of the multiple I/O ports 204 on the rotatable I/O module 203 is needed to connect the mobile computing device 200 to an external device (not shown), the I/O port module 203 is rotated to a working position where the I/O ports 204 face outward and become exposed and therefore accessible to users, as shown in FIG. 2A. When none of the I/O ports 204 are in use, the I/O port module 203 may be rotated to a hidden position where the I/O ports 204 face inward and become inaccessible and invisible to users, as shown in FIG. 2B. In this state, the I/O ports 204 are also protected. In this closed state, the back 207 of the rotatable assembly 203 may match in color or design with rest of the mobile device's exterior to provide a uniform aesthetics to the device. FIG. 2C illustrates the exterior view of the mobile computing device 200 with the rotatable I/O port module being rotated in between the two static positions.

Although for illustration purposes, the rotatable I/O port module 203 in FIG. 2A-2C appears to be different in shade from the main body 201 in accordance with embodiments of the present disclosure, every aspect of the I/O port module 203 exterior 207 may be designed to match the exterior design of the main body of the mobile computing device 201, such as color, bezel design, curvature, material, texture, pattern and so on. In some embodiments, the outside 207 of rotatable I/O port module 203 is substantially indistinguishable from the main body 201 of the device 200, especially when the module 203 is in hidden state. This adds to an overall pleasing aesthetics. However, in some other embodiments, the outside 207 of the I/O port module 203 may be visually distinguishable from the main body 201 to achieve a contrasting visual effect, e.g. so that the user knows where the I/O ports are located.

The rotatable I/O port module 203 illustrated in FIG. 2A-2C is arranged at one short side of the rectangular mobile computing device 200 surrounding the display panel 202 in one embodiment. In some other embodiments, the I/O port module 203 can be situated at any position of the mobile computing device 200 so long as it does not interfere with the functionalities of other components of the mobile computing device 200. In still some other embodiments, a plurality of rotatable I/O port modules can be included in a mobile computing device and may be situated in different regions of the mobile computing device in different orientations. Each of such I/O port modules may include different kinds of I/O ports depending on the conceivable functional need of the mobile computing device.

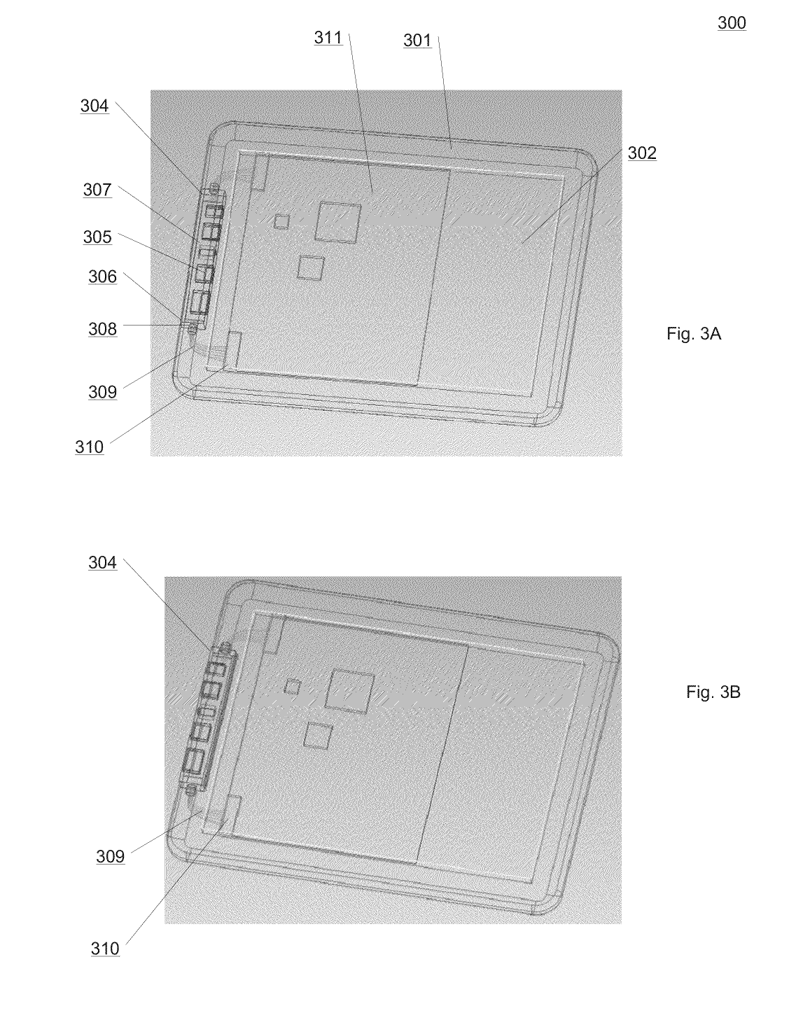

FIG. 3A illustrates the perspective view of a mobile computing device 300 with a rotatable I/O port module 304 being in the hidden state and connected to the main electronics or logic board 311 of the mobile computing device 300 in accordance with an embodiment of the present disclosure. The mobile computing device 300 comprises a main body 301, a display panel 302, a main board 311 that carries circuits and connections of the mobile computing device 300, and a rotatable I/O port module 304. The I/O port module 304 includes a number of I/O ports 305 that may be integrated on a Printed Circuit Board (PCB) 307, a housing 306 and two rotating axes 308. The I/O port module is rotatably mounted on the main body through the rotating axes 308. The I/O ports communicate with the circuits on the main board 311 via a bundle of wires 309. In some embodiments, the rotating axes 308 can be hollow such that the wire bundle 309 can be routed inside the axes. The wire bundle 309 is flexible about the axis of rotation of I/O port module 303. In some other embodiments, the rotating axes 308 carry electrical connectors connecting the wires from the I/O port module 304 and the wires to the main board 311.

In some embodiments, the wire bundle 309 can be made from any type of flexible cable, such as twisted cable, Flat Flexible Cable (FFC), Flexible Printed Circuit (FPC), ribbon cable, or coaxial cable, and the like. The I/O ports 305 in a rotatable I/O port module 304 can be of different kinds according to the functional need of the mobile computing device.

In some embodiments, the rotatable I/O port module 304 may also bear circuits (not shown) for controlling and/or configuring the I/O communications between the mobile computing device 300 with external devices. However, in some other embodiments, the control circuits 310 may be situated on the main board 311 of the mobile computing device 300 instead, as illustrated in FIGS. 3A and 3B.

FIG. 3B illustrates the perspective view of the mobile computing device 300 with the rotatable I/O port module 303 rotated to be in the working or accessible state. In some embodiments, the rotation range of the I/O module 303 may be limited to up to 180° to prevent the wire bundle 309 from over flexing.

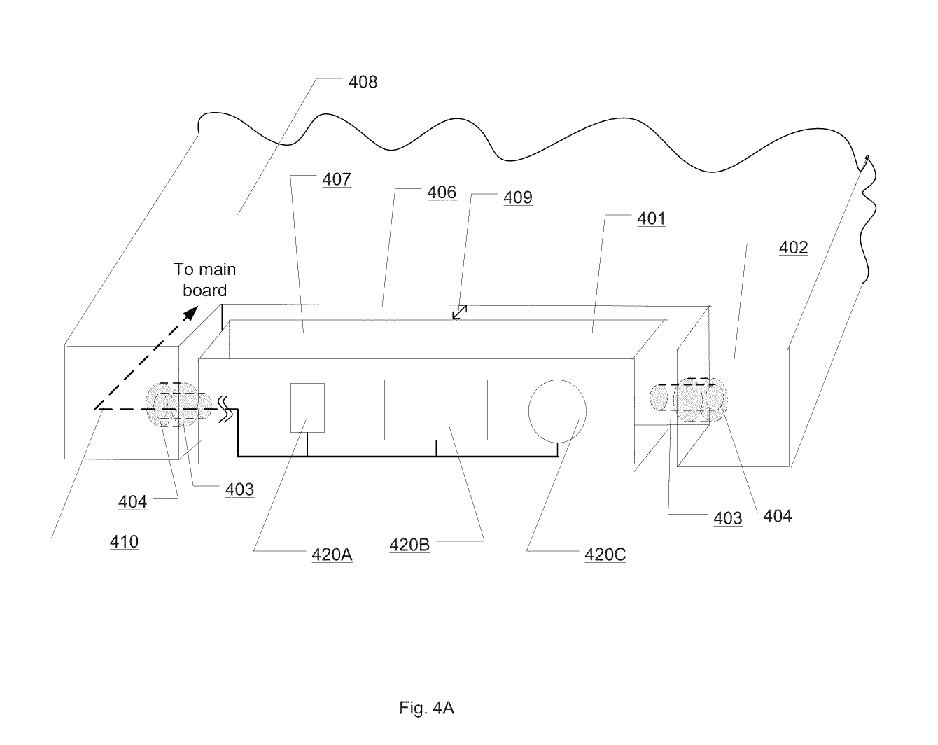

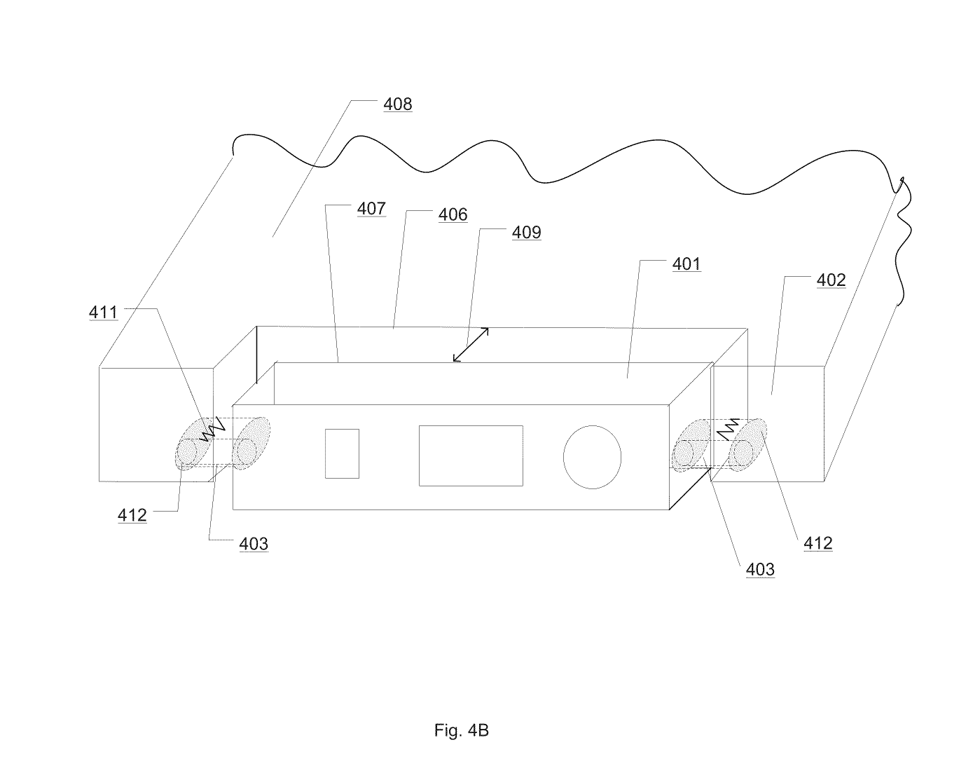

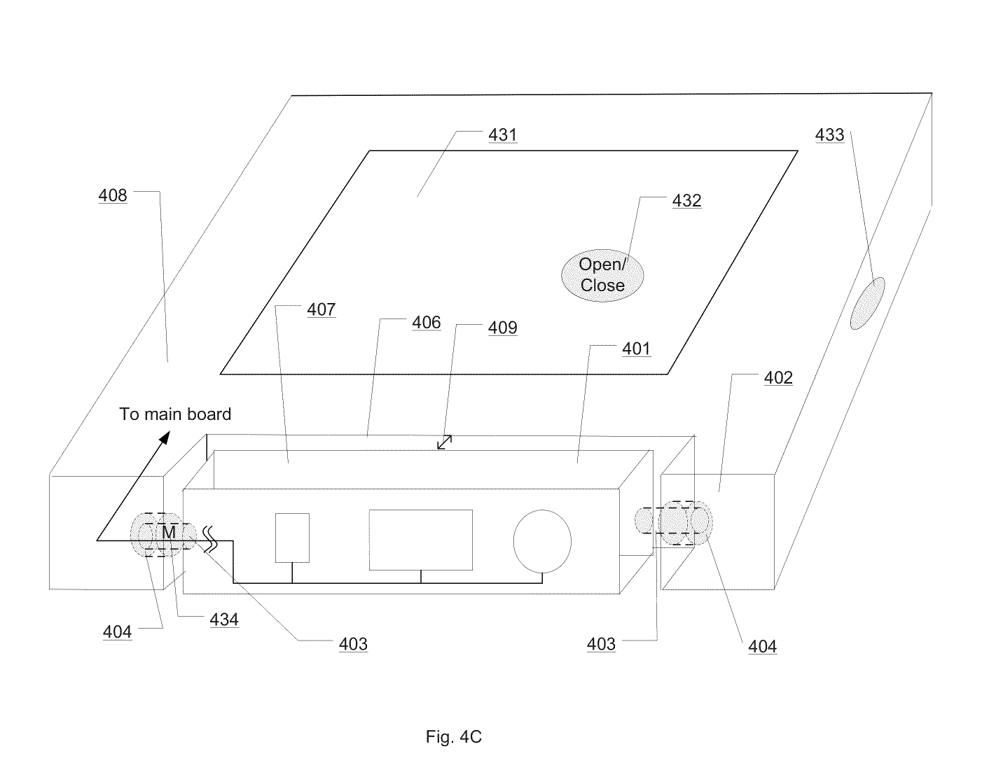

FIG. 4A illustrates a first rotation mechanism of the rotatable I/O port module 401 relative to the main body 402 in accordance with an embodiment of the present disclosure. The rotatable I/O port module 401 comprises I/O ports 420A, 420 B and 420C which electrically connect to the main board of the mobile computing device through the flexible cable 410. The two rotating axes 403 arranged respectively on two sides of the I/O port module 401 are inserted in the receiving trenches 404 located inside the main body 402, forming the rotation connection between the I/O port module 401 and the main body 402. A user can actuate the rotation by exerting a tangential force on the outside free edge of the I/O port module 401 in one embodiment. In some embodiments, a locking mechanism (not shown) can be employed to lock the I/O port module 401 in the hidden or working state to avoid unintended rotation. For example, a fastening bolt or a detent may be installed on the edges of the I/O port module and may be used to secure the I/O port module 401 to the main body 402 in the hidden or working state.

Because the rotational axes 403 in FIG. 4A are in fixed positions relative to the main body, in order for the I/O port module 401 to rotate without scraping the bordering edge 406 of the main body 402, a gap 409 of considerable width may be necessarily maintained between the back side 407 of the I/O port module 401 and the bordering edge 406 of the main body 402 when the I/O port module 401 is in either the hidden or working state.

FIG. 4B illustrates a second rotation mechanism of the rotatable I/O port module 401 relative to the main body 402 in accordance with an embodiment of the present disclosure. The second rotation mechanism allows the axes to move in a lateral direction parallel to the upper surface 408 of the main body 402 and, as a result, the gap 409 can be minimized to enhance the exterior aesthetics of the mobile computing device 400. Each axis 403 is coupled with the main body 402 through a recovering spring 411 that is disposed in each trench 412. The trenches 412 in FIG. 4B are wider in the lateral direction than the trenches 404 in FIG. 4B to allow lateral movement of the rotational axes 403. The recover springs 411 are oriented perpendicular to the axes 403 and parallel to the upper surface 408 of the mobile computing device 400. When the I/O port module 401 is in a static state, including the hidden state and the working state, the recovery springs 411 pull the I/O port module 401 towards the bordering edge 406 of the main body 402 by elasticity such that the gap 409 between the I/O port module 401 and the main body 402 is minimized.

To change the state of the I/O port module 401, a user can first pull the I/O port module 401 outwards to enlarge the gap 409 (as illustrated in FIG. 4B) and then exert a tangential force to rotate the module into the hidden state or working state. When the user releases the pulling force exerted on the I/O port module 401 afterwards, the gap 409 can close out automatically under the impact of the recovery springs 410.

FIG. 4C illustrates a third rotation mechanism of the rotatable I/O port module 401 relative to the main body 402 in accordance with an embodiment of the present disclosure. An axis 403 of the rotatable I/O port module 401 is attached to a motor 434 that drives the rotation of the I/O port module 401 relative to the mobile computing device 400. The motor 434 is communicably connected with a dedicated selective switch 433 installed on the I/O port module 401 or the main body 402 (as show in FIG. 4C). The user can change the state of the I/O port module by pushing the selective switch 433.

In an alternate embodiment, the motor 434 is controlled by a software installed in the mobile computing device 400. The software enables a user interface on the display panel 431. When the user sends a request for changing the state of the I/O module 401 by pressing the on-screen soft button 432 on a user interface display, the controller can respond to the request and drive the motor 434 to rotate the I/O port module 401 to a desired state. In still some other embodiments, the rotation can be actuated by electromagnetic force in association with suitable electromagnet components installed on the I/O module 401 and/or the main body 402.

In some embodiments, the rotatable I/O module may be automatically switched to hidden state from a working state or remain in hidden state whenever the mobile device 400 is powered off and nothing is connected to any port. This may be accomplished with the aid of a positional sensor to detect the state of the rotational I/O module 401 before the power off

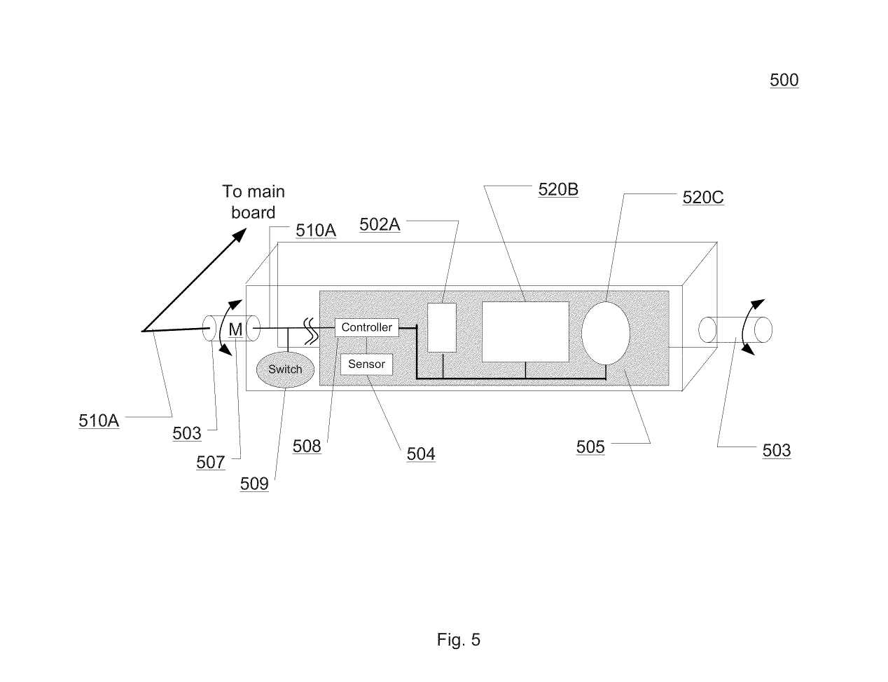

FIG. 5 depicts a configuration of a rotatable I/O port module in accordance with an embodiment of the present disclosure. The rotatable I/O port module 500 comprises a module body 501, a plurality of I/O ports 502A-502C and two rotational axes 503. As discussed above, the module body 501 may match the exterior design of the mobile computing device. One of the axes 503 is coupled with a motor 507 enabling user control on the rotation of the I/O port module 500 through a physical switch 509 or a software program installed on the mobile computing device. The I/O ports 502A-502C are integrated on a PCB board 505. A controller 508 including logic and power connection to drive the rotation of the I/O module 500 is situated in the PCB board. In some embodiments, the controller 508 may be situated on the main board of the mobile computing device.

In FIG. 5, one or both of the rotational axes 503 provide both the electrical and physical connections between the I/O port module 500 and the main body of the mobile computing device. The I/O port module 500 may electrically connect to the rotational axes 503 through a flexible cable 510A, as illustrated in FIG. 5. In some embodiments, the electrical connections may be implemented with rotatable electrical connectors without the need for a flexible cable. The rotational axes 503 are electrically connected to the main board through a second flexible cable 510B. In still some other embodiments, the rotational axes 503 provide no intermediate electrical connection between the I/O modules 500 and the main board, but only a physical route for the flexible cable connecting directly between the I/O port module and the main board to go through, as illustrated in FIG. 4A.

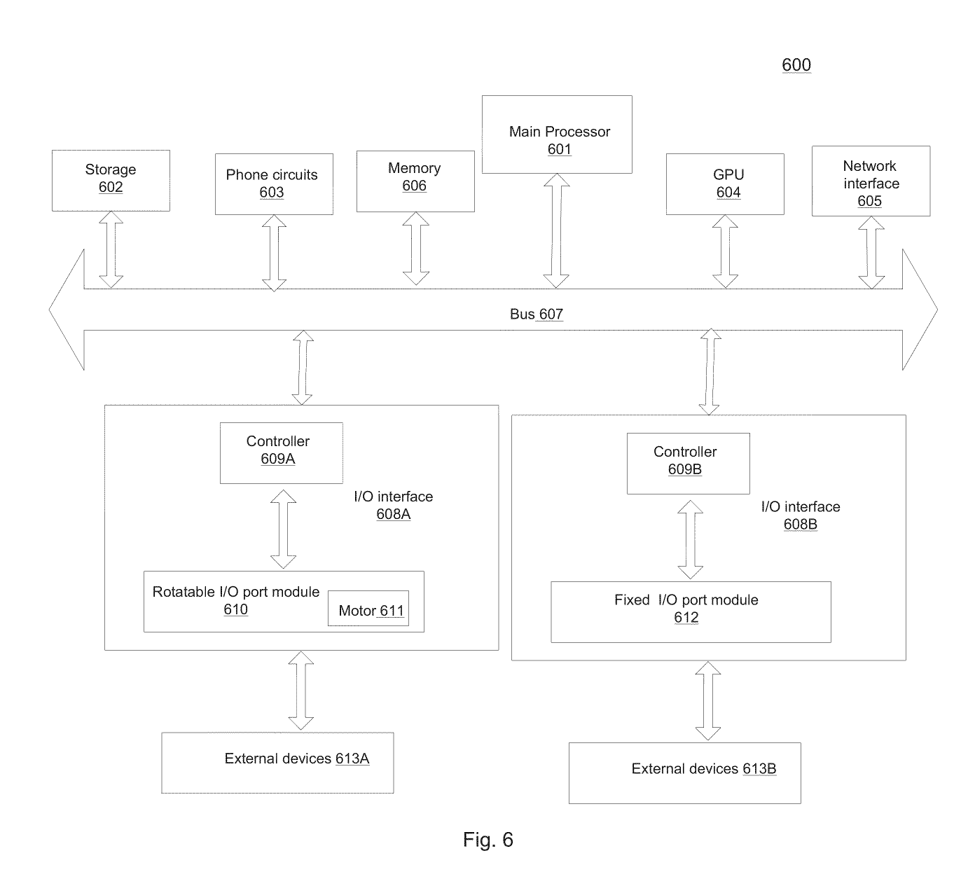

FIG. 6 is a functional block diagram describing a configuration of a mobile computing device 600 equipped with a rotatable I/O port module 610 in accordance with an embodiment of present disclosure. In some embodiments, the mobile computing device 600 can provide computing, communication and/or media play back capability. The mobile computing device 600 can also include other components (not explicitly shown) to provide various enhanced capabilities. The mobile computing device comprises a main processor 601 for processing electrical data, a memory 606, a Graphic Processing Unit (GPU) 604, network interface 605, a storage device 602, phone circuits 603, a rotatable I/O port module as well as other I/O interfaces 612.

The main processor 601 can be implemented as one or more integrated circuits and can control the operation of mobile computing device 600. In some embodiments, the main processor 600 can execute a variety of operating systems and software programs and can maintain multiple concurrently executing programs or processes. The storage device 602 can store user data and application programs to be executed by main processor 601, such as video game programs, personal information data, media play back program. The storage device 602 can be implemented using disk, flash memory, or any other non-volatile storage medium.

Network interface 605 can provide voice and/or data communication capability for mobile computing devices. In some embodiments, network interface can include radio frequency (RF) transceiver components for accessing wireless voice and/or data networks or other mobile communication technologies, GPS receiver components, or combination thereof. In some embodiments, network interface 605 can provide wired network connectivity instead of or in addition to a wireless interface. Network interface 610 can be implemented using a combination of hardware, e.g. antennas, modulators/demodulators, encoders/decoders, and other analog/digital signal processing circuits, and software components.

I/O interfaces 608A and 608B provide communications and controls between the mobile computing device 600 with other external I/O devices 613 (e.g. a computer, an external speaker dock or media playback station, a digital camera, a separate display device, a card reader, a disc drive, in-car entertainment system, a storage device, user input devices or the like) by way of conventional fixed I/O ports 612 as well as the rotatable I/O port module 610 that bears one or more I/O ports. The various I/O ports provide connections for power and ground as well as for various wired communication interfaces such as USB, FireWire (IEEE 1394 standard) and/or universal asynchronous receiver/transmitter (UART) for the mobile computing device 600. The controllers 609 for respective I/O interfaces include supporting circuitry for executing program codes to perform various operations associated with the external I/O devices 613.

In some embodiments, the controller 609A also includes logic circuitry and power connection to drive the rotation of the rotatable I/O module 610. For example, a user can send a request by operating an input control through a touchpad, a remote control, or voice dictation to invoke the rotation of the I/O module. In response to suitable programming code, the main processor 601 that has received the user request can send messages through the bus 607 to the controller 609 to drive the motor 611 that is attached to the rotatable I/O module 610, thereby changing the I/O module from hidden state to working state, or vice versa.

Although certain preferred embodiments and methods have been disclosed herein, it will be apparent from the foregoing disclosure to those skilled in the art that variations and modifications of such embodiments and methods may be made without departing from the spirit and scope of the invention. It is intended that the invention shall be limited only to the extent required by the appended claims and the rules and principles of applicable law.

What is claimed is:

1. A computing device comprising:
a display panel;
a main component board coupled to said display panel and comprising: a bus; a main processor coupled to said bus; and a memory coupled to said main processor;
a housing for containing said main component board and said display panel, said housing comprising a slot; and
an Input/Output (I/O) port module contained within said slot and comprising a plurality of I/O ports, said I/O port module communicatively coupled to said main component board and wherein said I/O port module is rotatable between a first position wherein said plurality of I/O ports are externally accessible and a second position wherein said plurality of I/O ports are externally hidden.

2. The computing device as described in claim 1 further comprising a rotatable axial connector wherein said rotatable axial connector couples said I/O port module to said housing.

3. The computing device as described in claim 2 wherein said plurality of I/O ports communicate with said main component board through a flexible cable that is disposed inside said rotatable axial connector.

4. The computing device as described in claim 2 wherein said rotatable axial connector further comprises a recovering spring that operates to lessen the gap between said housing and said I/O port module.

5. The computing device as described in claim 1 wherein said I/O port module comprises:
a first edge that is open to allow user access to said plurality of I/O ports when said I/O port module is in said first position; and
a second edge that resembles an outer edge of said housing, said second edge operable to hide said plurality of I/O ports when said I/O port module is in said second position.

6. The computing device as described in claim 5 wherein the said I/O port module is operable to rotate by a tangential force exerted on said first or said second edge of said I/O port module.

7. The computing device as described in claim 1 further comprising a motor attached to said I/O port module and wherein the said I/O port module is operable to rotate by said motor in response to a user request for changing the I/O module position submitted through a user interface component of said computing device.

8. The computing device as described in claim 1 wherein said housing comprises a long dimension and a short dimension and wherein further said slot is positioned along said short dimension.

9. The computing device as described in claim 1 wherein said plurality of I/O ports comprise a SIM port and a USB port.

10. The computing device as described in claim 1 wherein the said I/O port module further comprises a locking mechanism and is operable to be secured in said first and said second position by said locking mechanism.

11. The computing device as described in claim 1 wherein the said plurality of I/O ports further comprises a Printed Circuit Board (PCB) on which said plurality of I/O ports are integrated.

12. A rotatable I/O port module for use in a computing device, said rotatable I/O port module comprising
a plurality of I/O ports, each capable of providing said computing device connections with an external electronic device;
a module body that houses the plurality of I/O ports;
a rotatable axial connector operable to rotatably couple said rotatable I/O port module to a housing of said computing device.

13. The rotatable I/O port module as described in claim 12 wherein the rotatable axial connector is rotatable between a first position wherein said plurality of I/O ports are externally accessible and a second position wherein said plurality of I/O ports are externally hidden.

14. The rotatable I/O port module as described in claim 13 further comprising:
a first edge that is open to allow user access to said plurality of I/O ports when said I/O port module is in said first position; and
a second edge that resembles an edge of said housing, said second edge operable to hide said plurality of I/O ports when said I/O port module is in said second position.

15. The rotatable I/O port module as described in claim 14 wherein said rotatable axial connector is operable to rotate by a tangential force exerted at said first or second edge.

16. The rotatable I/O port module as described in claim 12 wherein said rotatable axial connector is further operable to communicatively couple said plurality of I/O ports to a main component board of said computing device via a flexible cable.

17. The rotatable I/O port module as described in claim 12 further comprising an electrical motor operable to drive the rotation of said rotatable I/O port module in response to a user request submitted through a user interface component of said computing device.

18. The rotatable I/O port module as described in claim 12 wherein said rotatable axial connector comprises a recovery spring that operates to lessen a gap between a housing of said computing device and said rotatable I/O port module.

19. The rotatable I/O port module as described in claim 12 further comprising control circuitry communicatively connected to said rotatable axial connector and operable to communicate to a main component board of said computing device, and configured to control the rotation of said rotatable I/O port module in response to signals sent from said main board component.

20. The rotatable I/O port module as described in claim 12 wherein said plurality of I/O ports comprise a SIM port and a USB port.

21. A mobile computing device comprising:
a display panel;
a main component board coupled to said display panel and comprising: a bus; a main processor coupled to said bus; and a memory coupled to said main processor;
a housing for containing said main component board and said display panel, said housing comprising an edge disposed slot; and
an Input/Output (I/O) port module contained within said edge disposed slot and comprising
a module body;
a plurality of I/O ports, said I/O port module communicatively coupled to said main component board and wherein said I/O port module is rotatable between a first position wherein said plurality of I/O ports are externally accessible and a second position wherein said plurality of I/O ports are externally hidden; and
a rotatable axial connector wherein said rotatable axial connector couples said I/O port module to said housing.

22. The mobile computing device as described in claim 21 wherein said rotatable axial connector comprises a flexible cable and wherein said plurality of I/O ports communicate with said main component board through the flexible cable disposed inside said rotatable axial connector.

23. The mobile computing device as described in claim 21 wherein said I/O port module further comprises:
a first edge that is open to allow user access to said plurality of I/O ports when said I/O port module is in said first position; and
a second edge that resembles an outer edge of said housing, said second edge operable to hide said plurality of I/O ports when said I/O port module is in said second position.
